(19) United States
(12) Patent Application Publication
(10) Pub. No.: US 2017/0284370 A1
(43) Pub. Date: Oct. 5, 2017

(54) METHOD FOR GENERATING AN ALTERNATING ELECTRIC CURRENT

(71) Applicant: WOBBEN PROPERTIES GMBH, Aurich (DE)

(72) Inventor: Albrecht GENSIOR, Dresden (DE)

(21) Appl. No.: 15/512,484

(22) PCT Filed: Sep. 9, 2015
(86) PCT No.: PCT/EP2015/070536

§ 371 Date: Mar. 17, 2017

(30) Foreign Application Priority Data
Sep. 22, 2014 (DE) 10 2014 219 052.5

(51) Int. Cl. F03D 9/25; H02P 9/10; H02K 7/18; H02J 3/38

(52) U.S. Cl. CPC F03D 9/255; H02J 3/386; H02P 9/107; H02K 7/183; H02J 3/01

(57) ABSTRACT

A method for generating an alternating electric current is provided. In the method, multiple partial currents are generated and superimposed into a total current. Each of the partial currents is generated using a modulation method. The modulation method uses a tolerance band method having tolerance limits that are changeable.

### BACKGROUND

1. Technical Field

The present invention relates to a method for generating an alternating electric current for feeding into an electric power supply network. Furthermore, the present invention relates to a corresponding feed-in device. The present invention also relates to a wind turbine including such a feed-in device.

2. Description of the Related Art

Particularly for wind turbines, it is known to generate alternating electric current for feeding into an electric power supply network, in which each of multiple inverters generate a partial current. These partial currents are superimposed into a total current. The superimposed total current is fed into the network.

Such partial currents are generated with the aid of a modulation method, which may also be referred to as pulse-width modulation. One fundamental method for generating such an alternating current is a so-called triangular modulation. Stated in a somewhat simplified manner, here, a sawtooth signal is superimposed on a desired sinusoidal waveform, and then, at each intersection of the sawtooth signal with the desired sinusoidal waveform, a corresponding semiconductor switch is closed or opened in order to trigger or terminate a voltage pulse. Such a method may also be referred to as a control for purposes of simplification, since neither the predefined sinusoidal signal nor the superimposed sawtooth is based on the generated result.

Another method is a tolerance band method. Here, a tolerance band, i.e., a lower deviation limit and an upper deviation limit, is placed around a sinusoidal function which corresponds to the desired current. The generated output current is then detected and compared with this tolerance band. If the current reaches the lower tolerance band limit, a switching pulse is triggered, and if the detected current reaches the upper tolerance band limit, the pulse is terminated. As a result, the current in the tolerance band varies about the predefined, idealized sinusoidal waveform.

An improvement on the quality of the generated current may be obtained particularly via a reduction of the tolerance band. Thus, if the band is made narrower, the current correspondingly varies less about the ideal sinusoidal waveform, and this also generally results in the switching frequency increasing, since the limits are narrower and the generated current therefore reaches them even more rapidly, thus triggering a switching action more rapidly.

In this respect, this method is well known and may also be used for individual partial currents which are then superimposed into a total current. This total current thus generated may then be fed into the electric power supply network.

As a result of this superimposition, which is ultimately a summation of these partial currents, the currents at any point in time basically add up. The instantaneous values of the currents at the particular point in time thus add up. As a result, a certain smoothing of the superimposed total current may also result. This may occur as a result of the fact that the particular positive and negative deviations of the many individual partial currents from the ideal sinusoid stand out completely or partially, in particular if these individual positive and negative deviations are statistically equally distributed. However, it may occur that many positive or many negative deviations of the individual partial currents merge, thus resulting in a correspondingly particularly high total deviation.

In order to prevent this, each of the individual tolerance bands may be made so narrow that even a theoretical addition of a positive deviation of the partial currents in each case does not exceed a desired maximum value for the total current.

That would also mean predefining particularly narrow tolerance bands which correspondingly result in particularly high frequencies. Thus, in order to carry out such a reliable limitation in this way in the case of ten inverters (each generating a partial current) each tolerance band would have to be set to a tenth of the width, which corresponds to the maximum allowable deviation of the total current. Consequently, ten times the switching frequency could result when modulating the currents. The complexity required for ensuring in this way that the generated total current does not assume a value which is too large is thus enormous.

The German Patent and Trade Mark Office have researched the following related art in the priority application for the present application: DE 40 23 207 C1 and an excerpt from Power Electronics and Variable Speed Drives by M. López et al. entitled ‘Control design for parallel-connected DC-AC inverters using sliding mode control’.

### BRIEF SUMMARY

An approach is to be provided which prevents a total output current from assuming deviations from the predefined sinusoidal waveform which are too strong, in a manner which is as simple and efficient as possible. An alternative approach is to be provided at least with respect to previously known approaches.

A method for generating an alternating electric current is provided. The method comprises the steps of generating multiple partial currents and superimposing the partial currents into a total current. Each partial current is generated using a modulation method which uses a tolerance band method having tolerance limits. For this purpose, it is now provided that the tolerance limits are changeable.

Therefore, normally wide tolerance bands may be used initially. Then, for example, if the total current upwardly exceeds the desired optimal sinusoidal waveform, it may be counteracted by, for example, lowering the tolerance limit for one, multiple or all of the partial currents. The reductions may also be different. In this case, the lower limit may be lowered as well, so that a higher frequency does not necessarily result.

Preferably, these tolerance limits are thus changed as a function of the generated total current. An indirect feedback may thus be achieved in terms of a control, however, without the particular individual currents being directly controlled. Rather, this feedback of the total current enters in via the change in the tolerance limits. According to one embodiment, it is provided that the tolerance limits of each of the modulation methods form a tolerance band having an upper and a lower tolerance limit. The upper and lower tolerance limits are changed independently of each other, or the tolerance band is shifted while retaining a constant distance between the lower and upper tolerance limits.

The tolerance band of each modulation method, i.e., for generating one of the partial currents in each case, has an upper and a lower tolerance limit, and in addition, it is provided that the upper and lower tolerance limits are changed independently of each other. For example, the upper tolerance limit may be lowered if necessary without changing the lower one, or vice-versa. Alternatively, it is provided that the tolerance band is shifted overall. By shifting the tolerance band, it is particularly achieved that the amplitude of each partial current may thereby be influenced without changing the switching frequency.

Preferably, the tolerance limits of the individual modulation methods of the partial currents are selected or changed by them in each case in such a way that the total current lies within a predefined tolerance limit. Accordingly, a tolerance limit or a tolerance band is predefined for the total current. The maintenance of this tolerance limit is then achieved by adjusting the individual tolerance limits of the partial currents. The triggering of direct switching operations thus does not occur if the total current reaches its tolerance limit, as is the case in the tolerance band method for each individual current, but rather, the control is carried out indirectly by changing the tolerance limits of the individual partial currents.

However, changing these individual tolerance limits does not have to wait until the total current reaches its tolerance limit or one of the two tolerance limits of the tolerance band. Instead or preferably, the distances of the total current from its tolerance limit may already result in a change, in particular, a shift, of the tolerance limits of the modulation methods of the individual partial currents. In addition or alternatively, a distance of the total current from the optimal waveform to be achieved, i.e., in particular the optimal sinusoidal waveform, may also be evaluated, and the tolerance limits of the individual modulation methods of the partial currents may be changed as a function thereof. For example, if the total current increases above its optimal value, the upper limits of the modulation methods may be lowered for the partial currents. If the total current should increase even further above its optimal value, the tolerance limits or, in this example, the upper tolerance limit of each modulation method of each partial current, may be lowered further. The same may of course also be carried out analogously for a decrease below the optimal value.

Preferably, for setting the tolerance limits, the partial currents and the total current are measured. Each individual modulation method thus also has the measured value of the total current as an input for measuring the particular partial current. The total current enters in simultaneously as a measured variable for multiple, in some cases a great many, modulation methods. Due to the provided method, it is also prevented that an overreaction is able to occur which could occur if, for example, in the case of a total current which is too high, all modulation methods were suddenly to respond and were to terminate each currently applied pulse. Preferably, the tolerance limits of the individual modulation methods are shifted at most up to the optimal value of the underlying curve in each case, i.e., up to the optimal sinusoidal waveform. This optimal underlying waveform, thus, forms the minimum value for the upper tolerance band limit and the maximum value for the lower tolerance band limit. As a result, it is possible to respond rapidly to a strongly deviating total current; however, the individual partial currents move about their optimal value, i.e., in the vicinity of the sinusoidal waveform to be set.

According to another embodiment, it is provided that the partial currents and the total current are transformed into a shared coordinate system in which limits to be complied with are predefined, so that the total current lies within a, or the, predefined tolerance limit. Preferably, such a transformation may be a transformation into a rotating coordinate system. Therefore, measured values and optimal values and limit values may be predefined, in particular, according to magnitude and phase. For the optimal value, only the phase would then change, but not the magnitude. The limit values could be defined more simply in the rotating coordinate system. However, the measured value would have to be recalculated each time.

In this respect, such a transformation also includes weighting currents with different values. This weighting, thus, constitutes a transformation, and that may indicate, for example, that the tolerance limits are changed differently for different partial currents as a function of the total current.

Such a weighting of the partial currents is particularly advantageous if transient currents occur between the individual partial currents, i.e., between the individual inverters. Such transient currents may also result in particular between the individual inverters if they are also galvanically connected to the same DC current input on the input side. If such transient currents are known, they are also included in each affected partial current as a component, but then are not incorporated into the total current. The correspondingly measured partial current, which is also fed back for the modulation method, thus does not correspond to the partial current which is then actually attributed to the total current. This may be taken into consideration in the case of a corresponding influencing of the limits via a weighting. Thus, the corresponding partial current is then no longer taken into consideration, but rather a transformation with the aid of this weighting.

In addition, a feed-in device is provided for feeding in electric current into an electric power supply network. Such a feed-in device includes multiple inverters, each having a partial current output, where a partial current is generated or provided at the partial current output in each case.

Furthermore, a sum current output is provided which sums up the partial currents to a total current, wherein the partial current outputs are connected to the sum current output at a summing node. In addition, a method is provided for generating the current according to one of the preceding embodiments. Preferably, the inverters are connected in parallel and include a line reactor at each of their partial current outputs. Preferably, only the line reactor is provided, without additional output filters. In particular, no otherwise common LCL filter is used, but rather only a network inductor or a line reactor. In the method, such a filter may in fact be dispensed with. By changing the tolerance bands as a function of the total current, such an otherwise common LCL filter may be dispensable. Thus, a particular smoothing or filtering of the individual currents may, thus, be dispensed with, so that on average, they are superimposed into a total current which is as favorable as possible and which in particular runs as closely as possible to the optimal value.

Preferably, only one inductor or network inductor, which may also be referred to as an L filter, is present between each partial current output and the summing node. Generally, the partial current outputs are also three-phase, and a three-phase line reactor is then preferably provided as an inductor in which the phases are magnetically coupled by, for example, using an inductor having a five-legged core.

Preferably, an additional line reactor at the sum current output may be dispensed with, since the provided method already results in individual currents which advantageously add up to the total current.

Furthermore, a measuring means for measuring each partial current is provided for setting the tolerance limits at each partial current output, and in addition, a measuring means is provided for measuring the total current at the sum current output. Here, a measuring means is sufficient which, however, feeds back its measured values to various inverters.

According to another embodiment, it is provided that the inverters, or some of them, are galvanically decoupled on the input side, and in addition or alternatively, on the output side. An input-side decoupling may, for example, mean that the input-side current busbars or DC current feeds are galvanically decoupled. For this purpose, for example, the generation of the direct current may already be generated at the generator in a galvanically isolated manner in multiple systems, particularly if a wind turbine is used, and correspondingly routed separately to the individual inverters.

A galvanic decoupling may also be carried out on the output side at a shared transformer. One option is for the transformer to have different taps. Galvanically isolated sub-windings of the shared transformer are then fed. Instead of a galvanic summing node, a magnetic summation results. The transformer may then form the summing node. Such a decoupling may be associated particularly well with the provided method of the total current-dependent tolerance band matching. In doing this, the individual currents are particularly preferably generated and may be superimposed correspondingly well into the total current. Transient currents may thereby be prevented.

In addition, a wind turbine is provided which is prepared for generating and feeding in electric current and which comprises a feed-in device according to one of the previously described embodiments for this purpose. The wind turbine thus includes multiple inverters which together generate the total current for the wind turbine for feeding into the power supply network.

### BRIEF DESCRIPTION OF THE SEVERAL VIEWS OF THE DRAWINGS

The present invention will be described in greater detail below by way of example on the basis of specific embodiments, with reference to the accompanying figures.

FIG. 1 shows a wind turbine in a perspective view.

FIG. 2 schematically depicts an interconnection of multiple inverters for generating a total current.

FIG. 3 illustrates a tolerance band method.

FIG. 4 shows a schematic structure for explaining a portion of a control method according to one embodiment.

### DETAILED DESCRIPTION

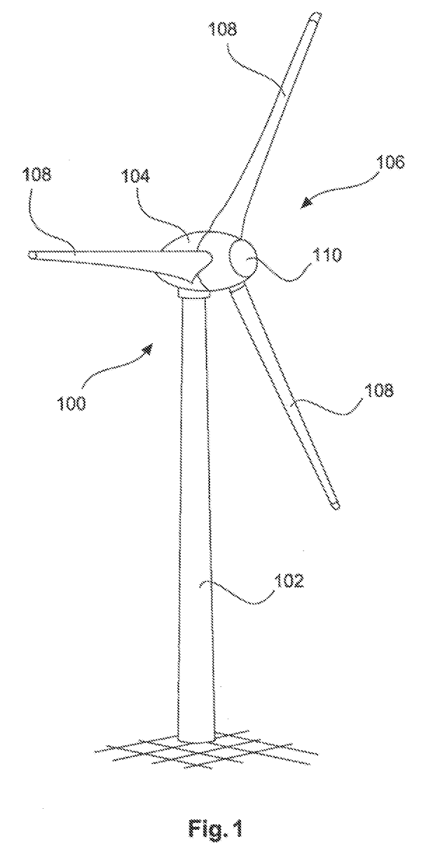

FIG. 1 shows a wind turbine 100 including a tower 102 and a nacelle 104. A rotor 106 having three rotor blades 108 and a spinner 110 is situated on the nacelle 104. During operation, the wind causes the rotor 106 to rotate, thus driving a generator in the nacelle 104.

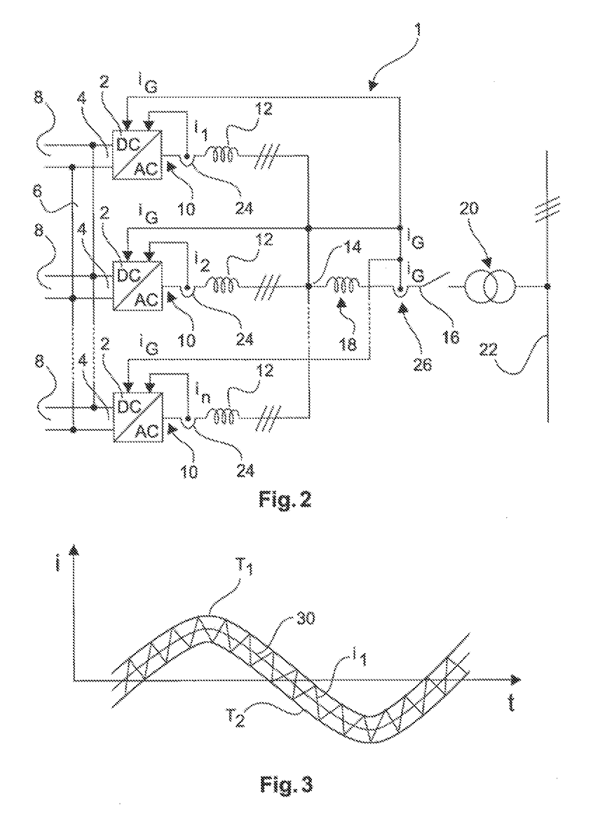

The circuit configuration according to FIG. 2 illustrates a feed-in device 1 and shows three inverters 2 which exemplify additional inverters. In this respect, these three inverters 2 also generate the partial currents i₁, i₂ and iₙ. The inverters 2 each have a DC voltage input 4, which may also be referred to as a DC input. The inverters 2 receive their input power via this DC input 4. These DC inputs 4 of the inverters 2 are coupled via a DC bus 6. However, according to one embodiment, it is also provided that these DC inputs 4 are not coupled, but are each connected to a separate DC source 8. FIG. 2 shows both of these options. A separation of the DC inputs 4 so that each DC input 4 is able to have a separate DC source 8 may, for example, be designed in such a way that one generator, in particular of a wind turbine, feeds separate DC sources 8. The inverters 2 now generate the output currents i₁, i₂ and iₙ at their outputs, each being referred to as a partial current output 10. The output of each inverter also includes an output inductor 12. After each output inductor, it is indicated that each inverter 2 generates a three-phase current. Thus, it is also to be inferred from FIG. 2 that this output inductor 12 may be sufficient at every partial current output 10 in the provided method. An otherwise common filter, in particular an LCL filter, is not required. The partial output currents i₁, i₂ and iₙ are superimposed at a summing node 14, i.e., added up, and routed to the sum current output 16 as the total current i_{G}. The sum current output has a shared network inductor 18 which, however, may also be dispensable. The total current i_{G} may then be fed in via a transformer 20 into the electric power supply network 22.

The additional functionality will now be explained by considering the currents. It is to be noted that both the partial currents at the output of each inverter 2 and the total output current at the sum current output 16 are three-phase. However, each of the additional explanations deals with only one phase of these three-phase currents. Thus, only one phase is considered, and the other phases function in the same manner.

In FIG. 2, it is now apparent that there is measuring means, which is a current sensor 24 for each partial current i₁, i₂ and iₙ. A current sensor 26 for the total current i_{G} is also provided.

Each inverter 2 now uses a measured value of its partial current, i.e., i₁, i₂ or iₙ, and also uses the measured value of the total current i_{G}. The total current i_{G} thus flows into each of the inverters 2. Each inverter then sets the corresponding tolerance band or the corresponding tolerance limits of the tolerance band as a function of the total current i_{G}, and then controls the corresponding semiconductor switches as a function of its partial current, in order to modulate a corresponding current.

Thus, the currents i₁, i₂ and iₙ are then generated, which already have an advantageous, low-oscillation state due to the type of their circuit and due to the output inductor 12, and are then superimposed at the summing node 14. The result is the total current i_{G}, whose measured value is fed back to each of the inverters 2, as described.

FIG. 3 illustrates an optimal sinusoidal curve 30 for a tolerance band method, about which a tolerance band having an upper tolerance limit T₁ and a lower tolerance limit T₂ is placed. For purposes of illustration, this tolerance band is depicted as being very wide, and would in reality of course be much narrower.

The generated current i₁, which is used here by way of example, lies in this tolerance band between the limits T₁ and T₂.

The current is generated by closing a switch for generating a positive pulse. As long as this positive pulse is applied, the current increases, and as soon as it has reached the upper limit T₁, the corresponding switch is reopened and the pulse is terminated. The current then decreases until it has reached the lower limit T₂, so that the aforementioned switch is then closed again, in order to explain the process graphically in a simplified manner.

FIG. 3 shows a tolerance band in which the optimal sinusoid 30 lies in the center, i.e., has equally large distances from the upper and lower limits T₁ and T₂. In order, for example, to take into consideration or to counteract a high total current, the upper limit T₁ may be shifted downward so that it approaches the optimal sinusoid 30. The lower limit T₂ may also be shifted downward, or it remains unchanged.

However, after such a shift of the tolerance band, i.e., the shifting of the upper limit T₁ described by way of example, the basic tolerance band method otherwise continues to run unchanged for the partial current i₁ shown by way of example in FIG. 3. Furthermore, the method thus tests whether the rising edge of the current has reached the upper tolerance limit T₁, which now, however, lies elsewhere, or whether its falling edge has reached the lower tolerance limit T₂.

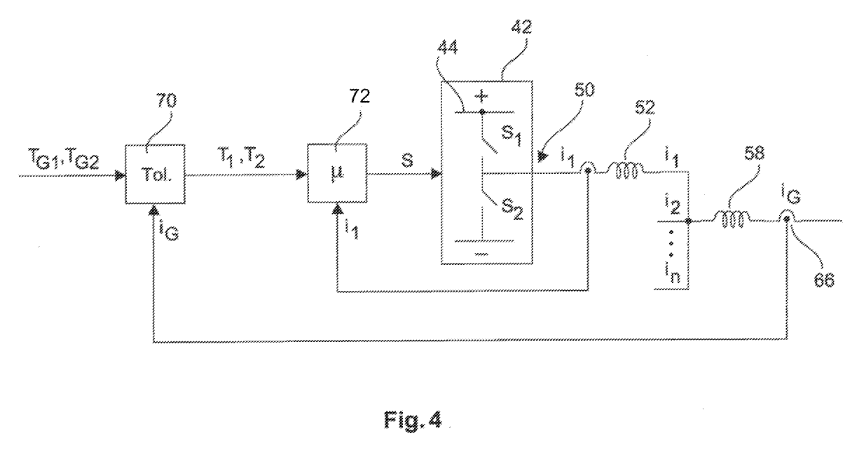

The method is depicted in FIG. 4 in a schematic structure which illustrates a feed-in device 41 or depicts it in a simplified manner. The actual generation of the partial current i₁ takes place in the inverter 42, which schematically indicates a DC link circuit 44 here. The two switches S₁ and S₂, which are situated between the positive and negative nodes, generate a voltage pulse pattern, so that the partial current i₁ at the partial current output 50 also results due to the output inductor 52. This partial current i₁ sums with various other partial currents i₂ to iₙ up to the total current i_{G}. A network inductor 58 may be provided for the total current i_{G}; however, the network inductor 58 may also be dispensable.

This total current i_{G} is measured using a total current meter 66 and input to a tolerance block 70. The tolerance block 70 may then predefine or change the specific upper tolerance limit T₁ and the lower tolerance limit T₂ for the total current, which were illustrated in FIG. 3, as a function of the total current and as a function of tolerance limits T_{G1} and T_{G2}. These upper and lower tolerance limits T₁ and T₂ are then input into the control unit 72. In addition, the control unit 72 receives the instantaneous partial current i₁ and then functions as illustrated in FIG. 3. Depending on the position of the partial current i₁ in the tolerance band which is determined via the upper and lower tolerance limits T₁ and T₂, switching signals S are then generated which may be provided to the inverter 42. The inverter 42 then correspondingly switches the switches S₁ and S₂. In particular for a positive pulse, the switch S₁ is closed and the switch S₂ is opened, and for the end of a positive pulse, or for a negative pulse, the switch S₂ is closed and the switch S₁ is opened.

A partial current i₁ then results, which is again fed back for the next calculation. A new value for the total current i_{G} also results, i.e., together with the additional currents i₂ to iₙ, and this value of the total current i_{G} is also fed back as described above.

In addition to this basic schematic description, particularly with respect to FIGS. 3 and 4, it may also be provided to transform the tolerance range, in particular an established tolerance range for the total current i_{G}, i.e., the tolerance limits T_{G1} and T_{G2} illustrated in FIG. 4, into suitable coordinates, in order to be able to be able to check the compliance via the total current in a better manner and/or to be able to derive better responses, in particular the change in the upper and lower tolerance limits T₁ and T₂. Correspondingly, a method is provided which comply with this tolerance range for the total current.

Therefore, the case is considered in which multiple power electronics systems are operated together, i.e., connected in series and/or in parallel, and controlled independently of each other with the aid of approximated sliding-mode controllers, which may also be referred to as tolerance band controllers or which may include such controllers. The sliding-mode controllers may, for example, be designed as hysteresis controllers. It may then be mostly ensured that the control deviation of the sliding function remains within certain tolerance bands for each subsystem.

However, since there is no synchronization of the switching actions in the individual subsystems, it may happen that the control deviation of interconnected systems simultaneously deviates in the same direction, so that a disadvantageous superimposition results. For this problem, a solution as described above is provided.

In order also to influence the superimposition of current or voltage ripples in a targeted manner, methods are generally used in practice which utilize a pulse-width modulation or a space-vector modulation. In this method, the switching frequency is generally fixed and the switching time points of interconnected systems are offset in a targeted manner, in order to achieve a desired superimposition of the current or voltage ripple.

One disadvantage of this approach is that it is necessary to forgo the advantages which are inherent in the sliding-mode controllers, i.e., in particular the characteristic in which certain interference is strongly suppressed.

Interconnected power electronics systems are operated in an approximated sliding mode in such a way that compliance with an established tolerance range is ensured whenever possible. By selecting the tolerance range in a suitable manner, a disadvantageous superimposition of harmonics in the sense of the above descriptions may be prevented or greatly reduced.

1. A method for generating an alternating electric current, comprising:
generating a plurality of partial currents; and
superimposing the plurality of partial currents into a total current, wherein:
each of the plurality of partial currents is generated using a modulation method,
the modulation method uses a tolerance band method having tolerance limits, and
the tolerance limits are changeable.

2. The method according to claim 1, wherein the tolerance limits are changed as a function of the generated total current.

3. The method according to claim 1, wherein the tolerance limits of the modulation method of a plurality of modulation methods form a tolerance band having an upper and a lower tolerance limit, and the method further comprises at least one of:
changing the upper and lower tolerance limits independently of each other, and
shifting the tolerance band while retaining a constant distance between the lower and upper tolerance limits.

4. The method according to claim 1, wherein the tolerance limits are selected such that the total current lies within a predefined tolerance limit.

5. The method according to claim 1, further comprising:
measuring the partial currents and the total current for setting the tolerance limits.

6. The method according to claim 1, further comprising:
transforming the partial currents and the total current into a shared coordinate system in which compliance limits are predefined such that the total current lies within a predefined tolerance limit.

7. The method according to claim 6, wherein the shared coordinate system is a rotating coordinate system.

8. A feed-in device for feeding in electric current into an electric power supply network, comprising
a plurality of inverters having a plurality of partial current outputs, respectively, each inverter of the plurality of inverters generating a respective partial current of a plurality of partial currents at a respective partial current output and an inverter of the plurality of inverters generating the respective partial current using a modulation method; and
a sum current output for summing up the plurality of partial currents to a total current, wherein the plurality of partial current outputs are connected to the sum current output at a summing node.

9. The feed-in device according to claim 8, wherein the plurality of inverters are connected in parallel and include a line reactor at each of their partial current outputs.

10. The feed-in device according to claim 8 wherein the plurality of inverters operate using a line reactor at each of their current outputs without an additional output filter or without an additional line reactor at the sum current output.

11. The feed-in device according to claim 8, further comprising:
a plurality of first measuring means at the plurality of partial current outputs, respectively, for measuring the plurality of partial current; and
a measuring means at the sum current output for measuring the total current.

12. The feed-in device according to claim 8 wherein one or more of the plurality of inverters are galvanically decoupled on at least one of an input side and an output side.

13. A wind turbine for generating and feeding the electric current into the electric power supply network, the wind turbine comprising:
a rotor;
a generator; and
the feed-in device according to claim 8.
